(19) United States
(12) Patent Application Publication
(10) Pub. No.: US 2021/0368067 A1
(43) Pub. Date: Nov. 25, 2021

(54) COORDINATE VALUES IN A COLOR SPACE

(71) Applicant: Hewlett-Packard Development Company, L.P., Spring, TX (US)

(72) Inventors: Javier MAESTRO GARCIA, Sant Cugat del Valles (ES); Jan MOROVIC, London (GB); Peter MOROVIC, Sant Cugat del Valles (ES)

(73) Assignee: Hewlett-Packard Development Company, L.P., Spring, TX (US)

(21) Appl. No.: 16/979,070

(22) PCT Filed: Apr. 6, 2018
(86) PCT No.: PCT/US2018/026539

§ 371 Date: Sep. 8, 2020

(51) Int. Cl. H04N 1/52; H04N 1/60; G06K 15/02; H04N 1/40; G01J 3/46; G01J 3/50

(52) U.S. Cl. CPC H04N 1/52; H04N 1/6025; G06K 15/1802; G01J 2003/467; G01J 3/462; G01J 3/50; H04N 1/40087

(57) ABSTRACT

Certain examples described herein relate to color spaces. In some cases, data representing a set of color values is obtained. Each color value has, for each of first, second and third axes defining a three-dimensional color space, a respective coordinate value. In some cases, for each of the set of color values, the coordinate value for the first and/or second axis is transformed dependent on the coordinate value for the third axis, to generate data representing a transformed set of color values. A set of output color values in an output color space is derived using the generated data. Output data associating the set of output color values in the output color space with a set of further color values in a further color space is generated.

### BACKGROUND

A printing system may include different printing fluids, e.g., colorants. By overprinting images for each of the printing fluids, an image with a range of different colors can be printed. An example printing pipeline may be calibrated so that printed colors are similar to or match desired colors, such as those defined in a digital format. Printing instructions may be provided based on values in an input color space. Associations between input color values and values in a print color space can be indicated to aid in printing according to printing instructions.

### BRIEF DESCRIPTION OF THE DRAWINGS

Various features of the present disclosure will be apparent from the detailed description which follows, taken in conjunction with the accompanying drawings, which together illustrate, by way of example, features of the present disclosure, and wherein:

FIG. 1 is a schematic diagram of a printing system according to an example;

FIG. 2 is a schematic diagram showing a representation of a Neugebauer Primary area coverage vector according to an example;

FIG. 3 is a flow chart illustrating a method according to an example;

FIGS. 4A and 4B are graphs showing color nodes projected onto a two-dimensional plane in a first and a second case respectively;

FIG. 5 is a graph showing a projection of a color node onto a two-dimensional plane according to an example; and

FIG. 6 is a schematic diagram of a processor and a computer readable storage medium with instructions stored thereon according to an example.

### DETAILED DESCRIPTION

Color can be represented within imaging devices such as print and display devices in a variety of ways. For example, in one case, a color as observed visually by an observer is defined with reference to a power or intensity spectrum of electromagnetic radiation across a range of visible wavelengths. In other cases, a color model is used to represent a color at a lower dimensionality. For example, certain color models make use of the fact that color may be seen as a subjective phenomenon, i.e. dependent on the make-up of the human eye and brain. In this case, a “color” may be defined as a category that is used to denote similar visual perceptions; two colors are said to be similar if they produce a similar effect on a group of one or more people. These categories can then be modelled using a lower number of variables.

Within this context, a color model may define a color space. A color space in this sense may be defined as a multi-dimensional space, with a point in the multi-dimensional space representing a color value and dimensions of the space representing variables within the color model. For example, in a Red, Green, Blue (RGB) color space, an additive color model defines three variables representing different quantities of red, green and blue light. In a digital model, values for these quantities may be defined with reference to a quantized set of values. For example, a color defined using an 8-bit RGB model may have three values stored in a memory, wherein each variable may be assigned a value between 0 and 255. Other color spaces include: a Cyan, Magenta, Yellow and Black (CMYK) color space, in which four variables are used in a subtractive color model to represent different quantities of colorant or printing fluid, e.g. for a printing system; the International Commission on Illumination (CIE) 1931 XYZ color space, in which three variables (X, Y and Z or tristimulus values) are used to model a color; the CIE 1976 (L*, a*, b*—CIELAB or ‘LAB’) color space, in which three variables represent lightness (L*) and opposing color dimensions (a* and b*); and the Yu′v′ color space, in which three variables represent the luminance (Y) and two chrominance dimensions (u′ and v′).

Other color spaces include area coverage spaces, such as the Neugebauer Primary area coverage (NPac) color space. An NPac vector in the NPac color space represents a statistical distribution of Neugebauer Primaries (NPs) over an area of a halftone. In a simple binary (bi-level, i.e. two drop states: “drop” or “no drop”) printer, an NP may be one of 2^{k}−1 combinations of k printing fluids within the printing system, or an absence of printing fluid (resulting in 2^{k} NPs in total). An NP may thus be seen as a possible output state for a print-resolution area. The set of NPs may depend on an operating configuration of a device, such as a set of available colorants. A colorant or printing fluid combination as described herein may be formed of one or multiple colorants or printing fluids. For example, if a bi-level printing device uses CMY printing fluids there can be eight NPs or output states. These NPs relate to the following: C, M, Y, CM, CY, MY, CMY, and W (white or blank indicating an absence of printing fluid). An NP may comprise an overprint of two available printing fluids, such as a drop of magenta on a drop of cyan (for a bi-level printer) in a common addressable print area (e.g. a printable “pixel”). An NP may be referred to as a “pixel state”.

In multi-level printers, e.g. where print heads are able to deposit N drop levels, an NP may include one of N^{k}−1 combinations of k printing fluids, or an absence of printing fluid (resulting in N^{k} NPs in total). A multi-level printer may use a piezo-electric or thermal print head that is capable of depositing different numbers of drops or different drop volumes, and/or may use multiple passes of a print head, to enact different drop states. For example, if a multi-level printer uses CMY printing fluids with four different drop states (“no drop”, “one drop”, “two drops” or “three drops”), available NPs can include C, CM, CMM, CMMM, etc. A “drop sequence” as used herein may define a set of drop states used or useable by a given printing system in a given operating state.

An NPac space provides a large number of metamers. Metamerism is the existence of a multitude of combinations of reflectance and emission properties that result in the same perceived color for a fixed illuminant and observer.

Each NPac vector may therefore define a probability distribution for colorant or printing fluid combinations for each pixel in the halftone (e.g. a likelihood that a particular colorant or printing fluid combination or available output state is to be placed or defined at each pixel location in the halftone). In this manner, a given NPac vector defines a set of halftone parameters that can be used in the halftoning process to map a color to NPs to be statistically distributed over the plurality of pixels for a halftone. Moreover, the statistical distribution of NPs to pixels in the halftone serves to control the colorimetry and other print characteristics of the halftone.

Spatial distribution of NPs according to the probability distribution specified in the NPac vector may be performed using a halftone method. Examples of suitable halftoning methods include matrix-selector-based Parallel Random Area Weighted Area Coverage Selection (PARAWACS) techniques and techniques based on error diffusion. This may result in discrete deposit instructions for print resolution pixels, e.g. instructing 0 to N drops of each of the k printing fluids on an addressable area of a print medium. Over a plurality of addressable areas, e.g. an area of print substrate, having a color defined by an NPac vector, the distribution of the printed output will tend towards the statistical distribution of area coverage defined by the NPac vector. An example of a printing pipeline that uses area coverage representations for halftone generation is a Halftone Area Neugebauer Separation (HANS) pipeline.

A color separation process may employ mappings between colors defined in a first color space and corresponding colors defined in a second color space. Such mappings may be stored in a data structure. For example, the mappings may be stored in a lookup table which may be accessed by the color separation process to map between the first and second color spaces. In some examples, a lookup table is used to map colorimetric values to vectors in an area coverage space. For example, the lookup table may map RGB or CMYK color values to NPac vectors. In some examples, the lookup table maps XYZ, LAB or any other color space used to specify a device color space. Where the vectors comprise NPac vectors, the lookup table may be referred to as a “HANS lookup table”. When an RGB mapping is used, the HANS lookup table may comprise 17³ entries. When a CMYK mapping is used, the HANS lookup table may comprise 9⁴ entries. The HANS lookup table may comprise a one-to-one mapping from input color values to NPac vectors.

Determination of the mappings between corresponding color values in different color spaces may be a complex and time-consuming process. Determination of the mappings may involve printing and color-measuring NPac vectors, and then assigning NPac vectors to input color values (e.g. RGB values) in a color lookup table based on the measured colorimetries of the NPac vectors. Where the output color space is an NPac color space, the dimensionality is defined by the total number of NP states that are available for a given printing system in a given operating state, which in some cases may be in the order of 100,000 states or more. The total number of NP states is in turn dependent on the number of different colorants or printing fluids used by the printing system. The number of possible colorant combinations grows exponentially as additional colorants are introduced into the printing system. Some printing systems may use at least 9 colorants, with some colorants having multiple implementable drop-weight states. Accordingly, due to the size and/or dimensionality of NPac space, manual pre-calculation of mappings for population of a lookup table may be impractical.

In some cases, a HANS lookup table can be populated by measuring a subset of available NPac vectors, and utilizing computational search and interpolation techniques to select NPac vectors for desired color transitions. Color-measured NPac vectors, as with any color values, may be represented in a color space. Such a color space may be represented in three dimensions, referred to herein as a “3D color space”. For example, color-measured NPac vectors may be represented in LAB space, where the position of a given NPac vector in LAB space corresponds to the measured colorimetry of that NPac vector. In some examples, the NPac vectors are represented in XYZ space. Searching for NPac vectors to map to a given color transition may involve traversing a 3D surface in the 3D color space. The 3D surface represents a gamut, or a portion thereof, defined by the range of NPac vectors that are implementable by the printing system. In a 3D color space, the gamut may have an arbitrary 3D shape. A desired color transition may correspond to a set of points in the 3D color space, the set of points describing a curve which substantially follows a part of the gamut surface. Characterizing a gamut shape as a 3D surface and performing interpolation using the 3D surface may be complex and/or impractical. Interpolation in 3D space may involve triangulation between 4 points and/or sampling in a dimension perpendicular to the 3D surface. In some cases, it may not be possible to accurately interpolate on the 3D surface. For example, 3D interpolation may result in interpolated points that are not on the surface. In other cases, interpolating the 3D surface in 3D space involves sophisticated computational models which may be prohibitively complex.

In some examples, a 3D surface representing a gamut in a 3D color space is projected onto a two-dimensional (2D) plane. Projecting the 3D surface onto a 2D plane may simplify the search and interpolation of color values and thus simplify the process of populating the color lookup table. A curved 3D surface in 3D space may correspond to a line on the 2D plane. The line may be a straight line. A color transition which is definable by a trajectory along a 3D surface in 3D color space may instead by defined by a trajectory along the corresponding line on the 2D plane. Traversing the line on the 2D plane may be less computationally complex than traversing the corresponding surface in the 3D color space. Interpolation on the 2D plane may involve triangulating between 3 points instead of 4, which is computationally simpler than interpolation in 3D color space.

Projecting a 3D color space onto a 2D plane may be considered a “collapsing” or “flattening” of one of the dimensions of the 3D color space. For example, when projecting a LAB color space onto an a/b plane, the L* dimension is collapsed. In some examples, more than one dimension of the 3D color space is collapsed. In some examples, a color space is representable in more than three dimensions. One or more of the dimensions of such color spaces may be collapsed in a similar manner to that described above. The collapsing of dimensions may be based on knowledge of the color properties of the colorants that are implementable by the printing system. For example, for a color transition that uses a single colorant, a color trajectory may be defined using a single given dimension, since values for the other two dimensions may be univocally tied to the values for the given dimension. However, collapsing a given dimension may result in a loss of information corresponding to the given dimension. For example, color values which, when represented in 3D color space are distinguishable due to having different L* values, may become indistinguishable when the L* dimension is collapsed. Information may be lost when collapsing dimensions for color transitions that involve multiple colorants. Such a loss of information may affect which color values, e.g. NPac vectors, are selected and/or used for interpolation to populate the color lookup table.

Accordingly, certain examples described herein provide techniques for allowing the dimensionality of a color space to be reduced whilst reducing an associated amount of useful information that is lost.

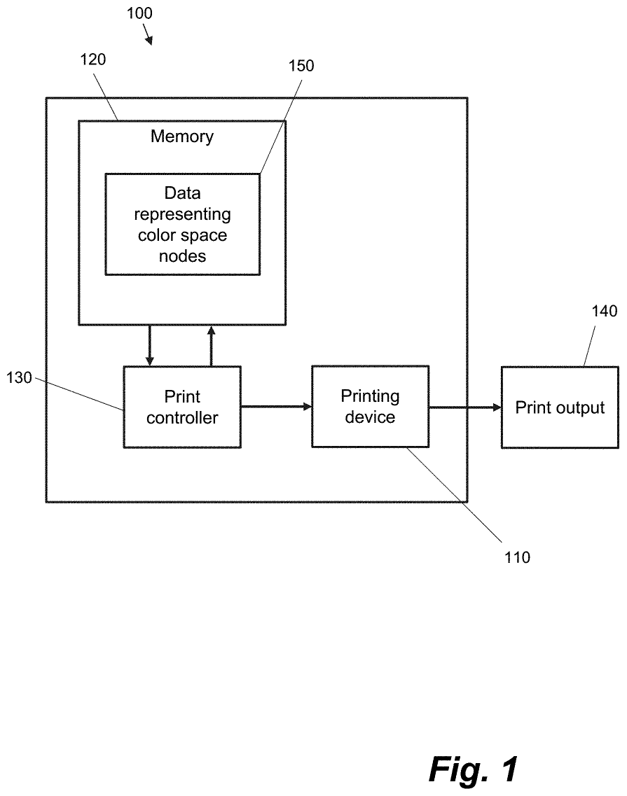

FIG. 1 shows a printing system 100 according to an example. Certain examples described herein may be implemented within the context of this printing system.

The printing system 100 may be a 2D printing system such as an inkjet or digital offset printer, or a 3D printing system, otherwise known as an additive manufacturing system. In the example of FIG. 1, the printing system 100 comprises a printing device 110, a memory 120 and a print controller 130. The print controller 130 may be implemented using machine readable instructions executed by a processing device and/or suitably programmed or configured hardware.

The printing device 110 is arranged to apply a print material, e.g., a printing fluid to a print target in a printing process, to produce a print output 140. The print output 140 may, for example, comprise colored printing fluids deposited on a substrate. The printing device 110 may comprise an inkjet deposit mechanism, which may for example comprise a nozzle to deposit printing fluid on the substrate. The inkjet deposit mechanism may include circuitry to receive instructions associated with depositing printing fluid. In 2D printing systems, the substrate may be paper, fabric, plastic or any other suitable print medium.

In an example, a printing fluid may be referred to as a “colorant”. A colorant may correspond to a given base color, where other colors may be formed from combinations of colorants. Examples of base colors include, but are not limited to, cyan, magenta, yellow, red, green and blue and black. The number of colorants implementable by the printing system 100 may be less than the number of possible colorant combinations, e.g. NPs, based on the given set of colorants.

In 3D printing systems, the print output 140 may be a 3D printed object. In such systems, the substrate may be a build material in the form of a powder bed comprising, for example, plastic, metallic, or ceramic particles. Chemical agents, referred to herein as “printing agents”, may be selectively deposited onto a layer of build material. In one case, the printing agents may comprise a fusing agent and a detailing agent. The fusing agent and detailing agent may control a temperature of a bed of build material. The fusing agent may comprise an energy-absorbing chemical compound that acts to increase a temperature of a portion of build material. The detailing agent may comprise a cooling agent, such as a water-based liquid, that acts to reduce a temperature of a portion of build material. In this manner, a fusing agent may be selectively applied to a layer in areas where particles of the build material are to fuse together, and a detailing agent may be selectively applied where the fusing action is to be reduced. In some examples, the printing agents may comprise colorants and may be deposited on a white or blank powder to color the powder. In other examples, objects may be constructed from layers of fused colored powder.

The memory 120 is arranged to store data 150 representing a set of color space nodes. Each color space node has, for each of first, second and third axes defining a 3D color space, a respective coordinate value. In other words, the 3D color space is defined by three axes, and a color node is representable within the 3D color space by three coordinate values, each corresponding to one of the three axes, which indicate a location in the 3D color space of the color node. A given axis may define and/or correspond to a given dimension of the color space. A color space node may also be referred to as a “color value” or a “point in color space”. A color space node or value may thus indicate a position in a color space which corresponds to a color. For example, a CIELAB color space is defined by three axes, namely L*, a* and b*. A color node in the CIELAB color space corresponds to a point in the CIELAB color space and may be represented by the “coordinates” or “set of coordinate values” (A, B, C), where A corresponds to the a* axis (and could be referred to as the “a*-coordinate”), B corresponds to the b* axis (and could be referred to as the “b*-coordinate) and C corresponds to the L* axis (and could be referred to as the “L*-coordinate”). For example, a color node having coordinates (40, −60, 70) in CIELAB space has an a*-coordinate of 40, a b*-coordinate of −60, and an L*-coordinate of 70.

In some examples, the set of color space nodes comprises two color space nodes having the same coordinate values as each other for, or corresponding to, the first and/or second axis and different coordinate values for the third axis. The term “the same” is used herein to indicate that the coordinate values may be substantially similar but may not be precisely equal. Coordinate values having a difference below a predetermined threshold value may be determined to be “the same”. For example, the coordinate values for the first and/or second axis may have a sufficient level of similarity so that the color space nodes, when projected onto a 2D plane comprising the first and second axes, are difficult to distinguish from one another. In some examples, the coordinate values of one of the color space nodes for the first and/or second axis are precisely equal to the coordinate values of another of the color space nodes for the first and/or second axis.

In some examples, the set of color space nodes comprises a set of area coverage vectors. An area coverage vector comprises a set of components that are to be distributed over an area of a halftone. As such, the set of output color values may comprise a set of halftone parameters. An example of an area coverage vector is an NPac vector. An NPac vector defines a statistical distribution of an operating set of colorant combinations, or NPs, implementable by the printing system 100 over an area of a halftone. In some examples, the set of output color values comprises a set of colorant-use vectors. A colorant-use vector may be an area coverage vector. A colorant-use vector comprises components corresponding to individual colorants implementable by the printing system 100. Values of the components correspond respectively to the amount of the corresponding colorant used relative to the other colorants represented in the colorant-use vector.

In examples where the set of color space nodes comprises a set of NPac vectors, the operating set of colorant combinations corresponds to an operating set of NPs. The operating set of colorant combinations may correspond to an operating state of the printing system 100 and/or of a printing process implemented by the printing system 100. An operating state may be a configuration of the printing system 100 that influences how the printing process is performed by the printing system 100. In examples, the operating state relates to a constraint of the printing process and/or of the printing system 100 implementing the printing process. For example, different printing systems may have different operating characteristics, relating to the constraints or capabilities of the different printing systems. In some examples, a given printing system may be configurable with different operating states, for example where a given operating state is associated with a given printing process of a plurality of printing processes performable by the printing system. A constraint may relate to the use of NPs over a HANS lookup table. An operating set of NPs may be a predetermined set of NPs over which a color lookup table can define NPac vectors. For example, the operating set of NPs may be dependent on a colorant drop sequence of a printing process performed by the printing system 100.

In some examples, the printing system 100 comprises a measurement device (not shown). The measurement device is arranged to obtain a measurement of an optical property of the color space nodes in the set of color space nodes. An example optical property to be measured is a reflectance spectrum. The measurement device may be arranged to obtain a measurement of the colorimetry of each color space node in the set of color space nodes. The colorimetry may be measured from one or more printed patches. The measured colorimetries may be useable to derive the coordinate values for the first, second and third axes for each of the color space nodes. The measurement device may be an optical measurement device. The optical measurement device may comprise a color measurement device. Examples of optical measurement devices include, but are not limited to, photodiodes, spectrophotometers, spectrofluorometers, spectrocolorimeters, tristimulus colorimeters, densitometers and lightness sensors. In some examples, the measurement device is separate from the printing system 100.

The measurement device may be communicatively coupled to the printing system 100, for example via an interface (not shown). In an example, the interface comprises a physical connection. The physical connection may be, for example, a Universal Serial Bus (USB) and/or serial data connection to electrically couple a measurement device such as a spectrophotometer and/or colorimeter, wherein data values are transmitted using an appropriate communication protocol over the interface. The interface may comprise a wired or wireless interface. In an example, the interface comprises a user interface. The user interface may, for example, comprise graphical components such as form fields to receive color measurement data, e.g. data output by a separate measurement device. In some examples, the interface is to receive input from an optical measurement device.

The print controller 130 is arranged to adjust, for each color space node of the set of color space nodes, the coordinate value for the first and/or second axis dependent on the coordinate value for the third axis, to obtain data representing an adjusted set of color space nodes. An adjustment to a coordinate value may be considered as a transformation of the coordinate value.

The coordinate value for the third axis may comprise a lightness value. In other words, the third axis may correspond to a lightness axis of the 3D color space. Points on the third axis may substantially indicate a “lightness”. For example, where the 3D color space is a CIELAB color space, defined with respect to opposing color dimensions (a* and b*) and a lightness dimension (L*), the third axis corresponds to the L* dimension. In such examples, the first and second axes correspond to the a* and b* dimensions. In other examples, the third axis corresponds to the a* dimension or the b* dimension.

In some examples, the print controller 130 is arranged to adjust, for each color space node in the set of color space nodes, the coordinate values for both the first and the second axis. The coordinate values for the first and the second axis may be adjusted using an exponential function. The exponential function has an output dependent on the coordinate value for the third axis.

The print controller 130 is further arranged to derive a set of halftone parameters using the obtained data representing the adjusted set of color space nodes. In some examples, the set of halftone parameters comprises a set of NPac vectors. The halftone parameters may be derived by interpolating between color space nodes in the adjusted set of color space nodes. In some examples, the halftone parameters are derived by selecting color space nodes from the adjusted set of color space nodes.

Due to the adjusting of the coordinate values for the first and/or second axis dependent on the coordinate values for the third axis, color nodes which may otherwise be indistinguishable when projected onto a 2D plane are instead distinguishable, as described in more detail below. As such, halftone parameters which more accurately represent a desired colorimetry, e.g. a colorimetry of a color transition, may be derived compared to a case in which the adjusting of the coordinate values is not performed. In some examples, no projection onto a 2D plane is performed. Color nodes may be separated from one another even when no projection onto a 2D plane is performed.

In some examples, the memory 120 comprises a lookup table for storing data mapping an input color space to an output color space. Data indicating the derived set of halftone parameters may be stored in the lookup table. For example, the lookup table may map colorimetric values to vectors in an area coverage space. Each vector in an area coverage space may comprise a set of halftone parameters. In some examples, the lookup table maps RGB or CMYK color values to NPac vectors.

The print controller 130 is further arranged to cause the printing device 110 to use the derived set of halftone parameters in a printing process. For example, print instructions may be received, comprising color values in an input color space. The print controller 130 may transform the color values in the input color space to halftone parameters using a color lookup table, and apply the halftone parameters indicated in the color lookup table during the printing process.

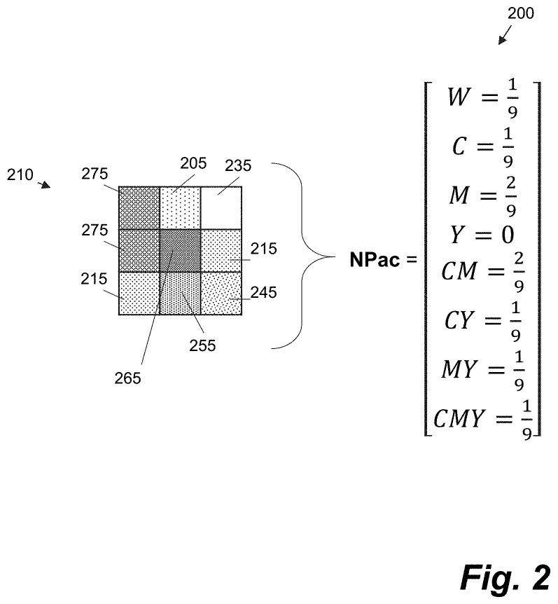

FIG. 2 shows an example NPac vector 200 for use in a CMY imaging system. The NPac vector 200 may correspond to an output color value derived in accordance with examples described herein. This example shows a three-by-three pixel area 210 of a print output where all pixels have the same NPac vector: vector 200. The NPac vector 200 defines the probability distributions for each NP for each pixel, for example a likelihood that NP, is to be placed at the pixel location. Hence, in the example print output there is one pixel of White (W) (235); one pixel of Cyan (C) (245); two pixels of Magenta (M) (215); no pixels of Yellow (Y); two pixels of Cyan+Magenta (CM) (275); one pixel of Cyan+Yellow (CY) (255); one pixel of Magenta+Yellow (MY) (205); and one pixel of Cyan+Magenta+Yellow (CMY) (265). Generally, the print output of a given area is generated such that the probability distributions set by the NPac vectors of each pixel are fulfilled. For example, the NPac vector may be effected by a halftone stage that implements the spatial distribution of colorants combinations defined by the vector, e.g. via a series of geometric shapes such as dots of predetermined sizes being arranged at predetermined angles. As such, an NPac vector is representative of the colorant overprint statistics of a given area. Although a CMY system is used for ease of explanation, other imaging systems may be used.

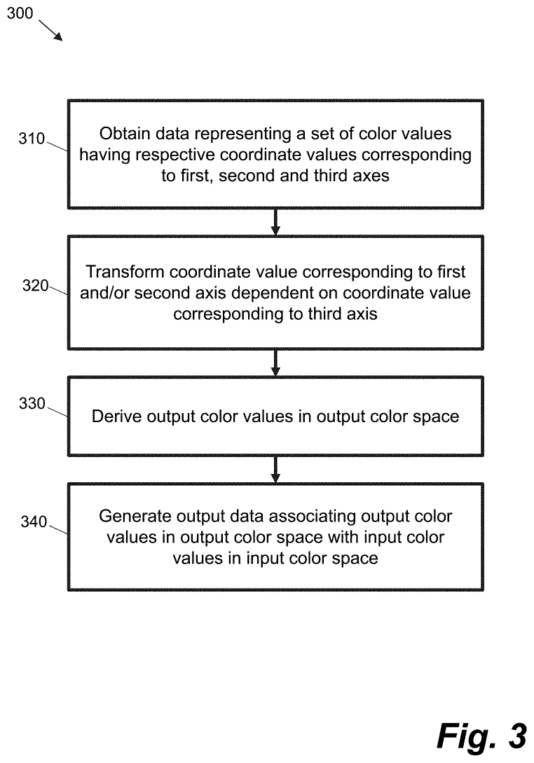

FIG. 3 shows a method 300 according to an example. In some examples, the method 300 is performed by a print controller such as the print controller 130 described with reference to FIG. 1. The print controller 130 may perform the method 300 based on instructions retrieved from a computer-readable storage medium. The printing system may comprise printing system 100.

At item 310, data representing a set of color values is obtained. Each color value has, for each of first, second and third axes defining a 3D color space, a respective coordinate value. In some examples, the data representing the set of color values comprises the set of color values. In some examples, the data representing the set of color values comprises the coordinate values for the set of color values. The data representing the set of color values may be generated or may be received from a further entity. In some examples, the set of color values comprises a set of NPac vectors.

In some examples, obtaining the data representing the set of color values comprises measuring a colorimetry of each color value of the set of color values. Based on the measured colorimetry of a given color value in the set of color values, the coordinate values for the first, second and third axes may be derived for the given color value. Therefore, the set of color values which may, for example, comprise a set of NPac vectors, can be represented in a 3D color space based on their measured colorimetries.

In some examples, the data representing the set of color values may be derived based on measurement data. For example, the coordinate values a given color value in the set of color values may be derived based on a measurement of the colorimetry of the given color value. Such measurement data may be received from a measurement device. The measurement device may be comprised in or separate from the printing system. The measurement data may be indicative of an optical property of a printed test patch. The measurement data may be indicative of a colorimetry of each of the set of color values. In some examples, the measurement data is received from a memory. The memory may be comprised in or separate from the printing system.

In some examples, the set of color values represented in the obtained data comprises two color values having different coordinate values for the third axis and the same coordinate values as each other for the first and/or second axis.

In some examples, the third axis corresponds to a lightness axis in the 3D color space. For example, where the 3D color space is a CIELAB color space, defined with respect to opposing color dimensions (a* and b*) and a lightness dimension (L*), the third axis corresponds to the L* dimension.

At item 320, for each color value of the set of color values, the coordinate value for the first and/or second axis is transformed dependent on the coordinate value for the third axis. In some examples, the coordinate values for both the first and the second axis are transformed dependent on the coordinate value for the third axis. Transforming the coordinate values for the first and/or second axis generates data representing a transformed set of color values. The transforming of the coordinate value for the first and/or second axis may be reversible.

In some examples, transforming the coordinate value for the first and/or second axis comprises applying a spreading function to the coordinate value for the first and/or second axis. The application of the spreading function acts to separate, or “spread”, the color values in a 2D plane comprising the first and second axes based on the respective coordinate values for the third axis. In some examples, transforming the coordinate value for the first and/or second axis comprises multiplying the coordinate value for the first and/or second axis by an exponential function. The exponential function has an output dependent on the coordinate value for the third axis. For example, where the third axis is a lightness axis in the 3D color space, the exponential function may include a parameter corresponding to lightness, such that the output of the exponential function is dependent on the lightness value of the input to the exponential function. Where the first and second axes comprise a* and b* axes in a CIELAB color space, multiplying both a* and b* coordinate values by the same L*-dependent value may enable the transformation to be hue-constant. In other words, the hue of the color values may not change as a result of adjusting both the a* and b* coordinate values by the same factor. Adjusting both the a* and b* coordinate values by the same factor may result in a change in chroma or colorfulness. Such a change may be reversible.

At item 330, a set of output color values in an output color space is derived using the data generated at item 320. The output color space may be a print color space. The set of output color values may comprise a set of halftone parameters. In some examples, the set of output color values comprises a set of NPac vectors. In other examples, the set of output color values comprises a set of colorant vectors in a colorant vector space. A colorant vector may have, for each colorant in the set of colorants implementable by the printing system, a vector component. An amount of a given colorant to be used over an area of a halftone may be represented by the value of the corresponding vector component of the colorant vector.

In some examples, deriving the set of output color values comprises selecting color values from the transformed set of color values. For example, each color value in the transformed set of color values and each output color value in the set of output color values may comprise an NPac vector. In this case, NPac vectors may be selected from the transformed set to form part of the output set.

In some examples, deriving the set of output color values comprises deriving an output color value in the set of output color values using data representing at least two color values in the transformed set of color values. For example, an output color value in the set of output color values may be derived by interpolating between at least two color values in the transformed set of color values. In some examples, an output color value in the set of output color values is derived by triangulating between color values in the transformed set of color values. Triangulation may comprise calculating a weighted average among multiple color values in the transformed set of color values. Such a weighted average may be calculated using a barycentric coordinate system or a trilinear coordinate system, for example. As such, the set of output color values may include a color value that is not in the transformed set of color values.

In some examples, the transformed set of color values is represented on a 2D plane comprising the first and second axes. The 2D plane is defined by the first and second axes. As such, the 2D plane may have a normal that is parallel to the third axis. In examples where the 3D color space comprises a LAB or CIELAB color space and the third axis corresponds to a lightness, or L*, dimension, the 2D plane may be an a*/b* plane. The set of output color values may be derived using the transformed set of color values represented on the 2D plane. For example, interpolation and/or triangulation may be performed on the transformed set of color values represented on the 2D plane. Due to the transforming of the coordinate values for the first and/or second axis dependent on the coordinate values for the third axis performed at item 320, color values which may otherwise be difficult to distinguish from one another when projected onto the 2D plane may instead be distinct and univocal. As such, output color values which more accurately represent a desired colorimetry may be derived compared to a case in which the transforming of the coordinate values is not performed. In some examples, the transformed set of color values is not represented on the 2D plane.

At item 340, output data is generated. The output data associates the set of output color values derived at item 330 with a set of further color values in a further color space. In some examples, the output data is stored in a color lookup table. Such a color lookup table maps the further color space to the output color space. As such, the further color values in the further color space may be considered as inputs to the mapping defined by the output data stored in the color lookup table. For example, the further color space may be an RGB or CMYK color space. In some examples, the further color space is an input device color space. In examples where the set of output color values comprises a set of NPac vectors, the color lookup table comprises a HANS lookup table.

In some examples, print control data is received for a printing operation. The print control data comprises the set of further color values in the further color space. In other words, the set of further color values in the further color space may be provided as an input for a printing operation. The output data may then be used to perform the printing operation using the set of output color values. For example, the output data may be used to map from the received further color values to the output color values, such that the output color values can be used in the printing operation. Therefore, the set of color values comprised in the print control data, namely the set of further color values, may be expressed as color values in the print color space of the printer, namely the set of output color values, in order for the printer to perform the printing operation based on the print control data.

In some examples, the output data associates the set of output color values in the output color space with transition points between vertices in the further color space. The further color space, which may be for example an RGB or CMYK color space, may be represented as a 3D cube. The cube has eight vertices, each vertex corresponding to one of the primary or secondary colors of the color space, or black or white. For example, the vertices may correspond to: red, green, blue, cyan, magenta, yellow, black and white. Each pair of vertices may be connected by a color transition or ramp. Examples of such transitions include white-red, cyan-blue, black-green, etc. A given transition may comprise a plurality of transition points along the transition. A color transition may therefore be defined by a trajectory along successive transition points.

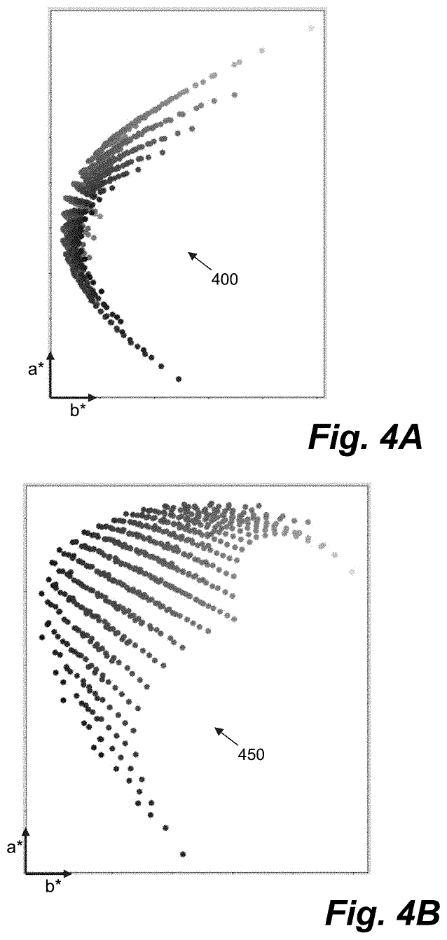

FIG. 4A is a graph 400 showing color nodes projected onto a 2D plane according to a first case. The first case comprises a comparative example wherein the examples described with respect to FIG. 1 or 3 are not used. In this example, the 2D plane is an a*/b* plane, onto which color nodes representable in a 3D CI ELAB space are projected. Color nodes having different lightness values, namely different L* values in CIELAB space, are depicted in the graph 400 with different shades of gray. Darker points on the graph 400 correspond to smaller L* values and lighter points correspond to greater L* values.

The color nodes shown in the graph 400 correspond to a part of a gamut of a printing system, where the gamut is representable as a 3D surface in a 3D color space. The part of the gamut represented in the graph 400 corresponds to a color transition from white to green. To describe the white-green transition, a set of color nodes are defined which describe a curve from white to green points on the 3D surface. However, parts of the 3D surface may have a convex curvature, in which case multiple color nodes can have similar values for two of the three dimensions of the color space, differing, e.g., by the respective values for the third dimension. When the dimensionality of the color space is reduced, e.g. by projecting onto a 2D surface, such commonality between color nodes can lead to ambiguity. The projection of the curved 3D surface onto the 2D plane may be considered as a “folding” of the 3D surface.

In this comparative example, multiple color nodes having different L* values but similar a* and b* values are difficult to distinguish from each other when projected onto the a*/b* plane. Information is effectively lost due to the projection onto the a*/b* plane, since color nodes that differ only by lightness are difficult to distinguish from one another. In some examples, color nodes that differ only by lightness are indistinguishable from one another when projected onto the a*/b* plane.

FIG. 4B is a graph 450 showing color nodes projected onto a 2D plane according to one of the examples described herein. Similarly to the graph 400 shown in FIG. 4A, in the example shown in FIG. 4B, the 2D plane is an a*/b* plane, onto which color nodes representable in a 3D CIELAB space are projected. Color nodes having different lightness values, namely different L* values in CIELAB space, are again depicted with different shades of gray. In this example, darker and lighter color nodes are separated due to the adjusting of the a* and b* coordinates dependent on the L* coordinate. For example, color nodes having different lightness values may be separated on the 2D plane by multiplying the a* and b* values of the color nodes by an L*-dependent exponential function. Separating the color nodes on the 2D plane reduces ambiguity between color nodes having different lightness values, thereby facilitating accurate selection and/or interpolation for generating a color mapping. The adjusting of the a* and b* coordinates to separate color nodes on the 2D plane may be considered an “unfolding” of the “folded” 3D surface. For example, color nodes which otherwise would be indistinguishable, or at least difficult to distinguish, using their respective a* and b* values may, after the adjusting of the a* and b* values in dependence on the corresponding L* values, be univocally identifiable using their respective a* and b* values. As such, color nodes may be selected and/or interpolated to represent smooth color transitions. The color nodes shown in the graph 450 form a series of bands. Each band comprises values having similar a* and b* values but different L* values.

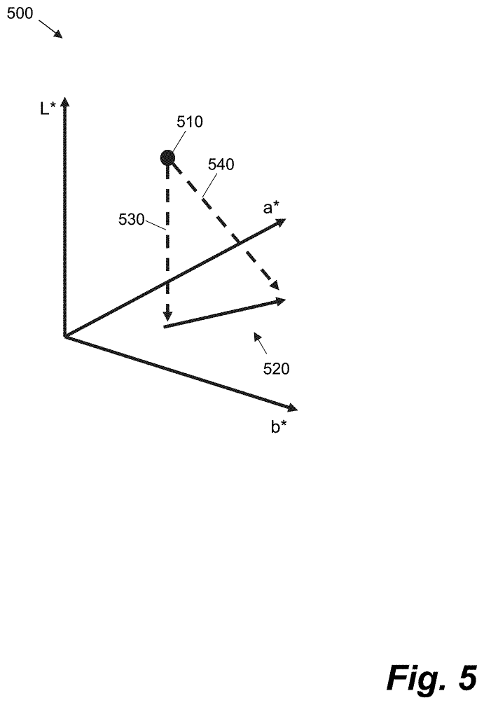

FIG. 5 is a graph 500 showing a color node 510 projected onto a 2D plane 520. In this example, the color node 510 is representable in a 3D CIELAB color space, and the 2D plane 520 is an a*/b* plane. In other words, the 2D plane 520 comprises the a* and b* axes of the 3D color space. The 2D plane 520 has a normal that is perpendicular to the a* and b* axes and that is parallel to the L* axis. The 2D plane may be an L*/a* plane or an L*/b* plane in other examples.

A first projection 530 of the color node 510 onto the 2D plane 520 illustrates schematically a comparative case in which the a* and b* coordinates of the color node 510 are not adjusted in accordance with the examples described herein. The first projection 530 of the color node 510 has the same a* and b* coordinates as the initial color node 510 itself.

A second projection 540 of the color node 510 onto the 2D plane 520 illustrates schematically a case in which the a* and b* coordinates of the color node 510 are adjusted based on the L* coordinate of the color node 510. The color node 510 is projected via the second projection 540 onto a different location on the a*/b* plane 520 compared to a case in which the a* and b* coordinates are not adjusted.

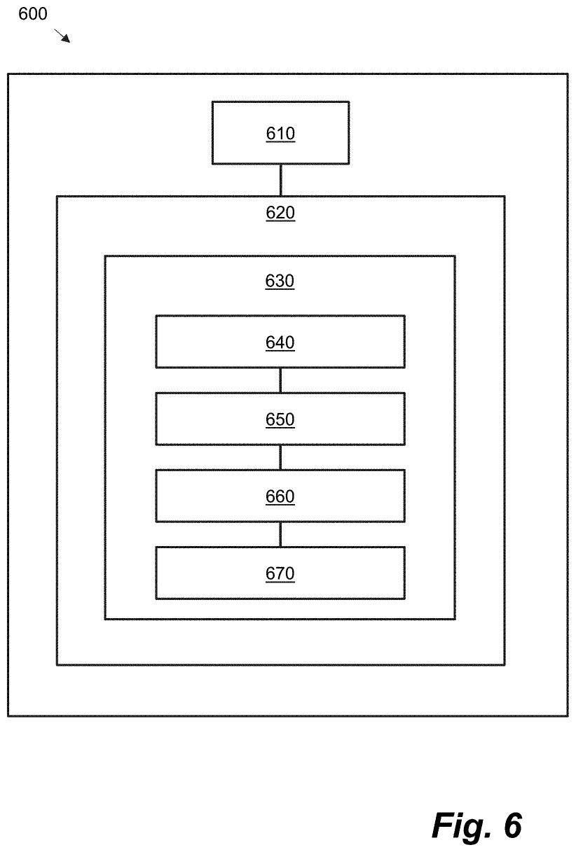

FIG. 6 shows example components of a printing system 600, which may be arranged to implement certain examples described herein. A processor 610 of the printing system 600 is connectably coupled to a computer-readable storage medium 620 comprising a set of computer-readable instructions 630 stored thereon, which may be executed by the processor 610. The printing system 600 may comprise a printing system similar to printing system 100.

Instruction 640 instructs the processor 610 to obtain data representing a set of color values. Each color value in the set of color values has, for each of first, second and third axes defining a 3D color space, a respective coordinate value.

Instruction 650 instructs the processor 610 to adjust, for each color value of the set of color values, the coordinate value for the first and/or second axis dependent on the coordinate value for the third axis, to generate data representing an adjusted set of color values.

Instruction 660 instructs the processor 610 to derive a set of output color values in an output color space using the generated data. The set of output color values may comprise a set of NPac vectors, for example.

Instruction 670 instructs the processor 610 to generate output data mapping a set of further color values in a further color space to the set of output color values in the output color space. In some examples, the generated output data is stored in a color lookup table. The color lookup table may be stored in a memory of the printing system 600. The further color space may comprise an input color space. As such, the output data maps an input color space to an output color space. Input color values in the input color values may be input to the printing system 600 as part of printing instructions, and subsequently converted to output color values by the processor 610 using the output data, to allow a printing operation to be performed using the output color values. The output color space may comprise a print color space, for example.

Processor 610 can include a microprocessor, microcontroller, processor module or subsystem, programmable integrated circuit, programmable gate array, or another control or computing device. The computer-readable storage medium 620 can be implemented as one or multiple computer-readable storage media. The computer-readable storage medium 620 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 630 can be stored on one computer-readable storage medium, or alternatively, can be stored on multiple computer-readable storage media. The computer-readable storage medium 620 or media can be located either in the printing system 600 or located at a remote site from which computer-readable instructions can be downloaded over a network for execution by the processor 610.

Certain examples described herein enable sets of NPac vectors to be selected and/or derived which produce smooth, visually pleasing color transitions. Thus, a resulting visual quality of output images may be increased compared to a case in which the examples described herein are not used. By disambiguating NPac vectors which, when projected onto a 2D plane, would otherwise be difficult to distinguish from one another, finer control may be obtained in the selection and/or derivation of NPac vectors to represent the color transitions. The likelihood of “jumping” between NPac vectors having substantially different lightness values in a given region of a color transition is reduced, thus increasing the resulting visual smoothness of the transition. Further, by traversing a 3D surface in a 3D color space that is projected onto a 2D plane, NPac vectors may be selected and/or derived which utilize the full gamut of the printing system.

Certain examples described herein enable a color lookup table mapping between color spaces to be populated computationally. Such examples may be less time-consuming, less error-prone and/or involve less user burden than comparative methods in which lookup tables are populated manually, e.g. through trial and error. Computational methods such as those described herein may be performed without a human expert being present to visually inspect and/or select color values to populate the lookup table.

Certain examples described herein reduce an amount of information lost due to projecting color values representable in a 3D color space onto a 2D plane. Projecting color values onto a 2D plane facilitates simpler computation for searching and/or interpolating the color values, e.g. for obtaining color transitions, compared to using color values represented in 3D color space. Examples described herein thus enable computation to be simplified whilst reducing a likelihood of useful information being lost. Less information may be lost compared to a case in which the described examples are not used.

Certain examples described herein enable smooth transitions to be obtained in a print color space, where a given transition involves multiple different printing fluids. For example, green transitions may involve green, cyan and yellow colorants, each of which has a different lightness, and whose combinations give rise to complex 3D surfaces. For such complex color transitions involving several printing fluids or colorants, reducing the dimensionality of the color space may reduce the likelihood of a smooth output. By adjusting the coordinate values for the first and second axes dependent on the coordinate value for third axes, color nodes can be reversibly separated from one another, allowing color nodes which would otherwise be indistinguishable to be identified, and thus enabling smooth transitions to be obtained even for complex cases involving multiple different colorants.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method comprising:
obtaining data representing a set of color values, each color value having, for each of first, second and third axes defining a three-dimensional color space, a respective coordinate value;
transforming, for each color value of the set of color values, the coordinate value for the first and/or second axis dependent on the coordinate value for the third axis, to generate data representing a transformed set of color values;
deriving a set of output color values in an output color space using the generated data; and
generating output data associating the set of output color values in the output color space with a set of further color values in a further color space.

2. The method of claim 1, wherein the set of output color values comprises a set of Neugebauer Primary Area Coverage (NPac) vectors, each NPac vector defining a statistical distribution of Neugebauer Primaries (NPs) over an area of a halftone.

3. The method of claim 1, wherein the set of color values represented in the obtained data comprises two color values having different coordinate values for the third axis and the same coordinate values as each other for the first and/or second axis.

4. The method of claim 1, wherein the transformed set of color values is represented on a two-dimensional plane comprising the first and second axes.

5. The method of claim 1, wherein the deriving the set of output color values comprises deriving an output color value in the set of output color values using data representing at least two color values in the transformed set of color values.

6. The method of claim 1, wherein transforming the coordinate value for the first and/or second axis comprises multiplying the coordinate value for the first and/or second axis by an exponential function having an output dependent on the coordinate value for the third axis.

7. The method of claim 1, wherein the third axis corresponds to a lightness axis in the three-dimensional color space.

8. The method of claim 1, wherein the output data associates the set of output color values in the output color space with transition points between vertices in the further color space.

9. The method of claim 1, comprising:
receiving print control data for a printing operation, the print control data comprising the set of further color values in the further color space; and
using the generated output data to perform the printing operation using the set of output color values.

10. The method of claim 1, comprising storing the generated output data associating the set of output color values in the output color space with the set of further color values in the further color space in a color lookup table.

11. The method of claim 1, wherein the obtaining the data representing the set of color values comprises:
measuring a colorimetry of each color value of the set of color values; and
deriving, for each color value in the set of color values, the coordinate values for the first, second and third axes based on the measured colorimetry.

12. A printing system comprising:
a printing device to apply a print material to a print target in a printing process;
a memory to store data representing a set of color space nodes, each color space node having, for each of first, second and third axes defining a three-dimensional color space, a respective coordinate value; and
a print controller to:
adjust, for each color space node of the set of color space nodes, the coordinate value for the first and/or second axis dependent on the coordinate value for the third axis, to obtain data representing an adjusted set of color space nodes;
derive a set of halftone parameters using the obtained data; and
cause the printing device to use the set of halftone parameters in the printing process.

13. The printing system of claim 12, wherein the set of color space nodes comprises two color space nodes having the same coordinate values for the first and/or second axis and different coordinate values for the third axis.

14. The printing system of claim 12, wherein the print controller is to adjust, for each color space node in the set of color space nodes, the coordinate values for the first and the second axis using an exponential function having an output dependent on the coordinate value for the third axis.

15. A non-transitory computer-readable storage medium comprising a set of computer-readable instructions that, when executed by a processor of a printing system, cause the processor to:
obtain data representing a set of color values, each color value having, for each of first, second and third aces defining a three-dimensional color space, a respective coordinate value;
adjust, for each color value of the set of color values, the coordinate value for the first and/or second axis dependent on the coordinate value for the third axis, to generate data representing an adjusted set of color values;
derive a set of output color values in an output color space using the generated data; and
generate output data mapping a set of further color values in a further color space to the set of output color values in the output color space.
